(19) United States
(12) Patent Application Publication
(10) Pub. No.: US 2026/0252671 A1
(43) Pub. Date: Aug. 27, 2026

(54) AUTHORIZATION REQUEST ROUTING IN A CELL-BASED AUTHORIZATION REQUEST PROCESSING SYSTEM

(71) Applicant: Capital One Services, LLC, McLean, VA (US)

(72) Inventors: Raja CHATTOPADHYAY, Glen Allen, VA (US); Walker SENSABAUGH, Henrico, VA (US); Kyle HEIDE, Midlothian, VA (US); Margaret COOK, Chicago, IL (US); William A. BIGGINS, Glen Allen, VA (US); Tyler O'CONNELL, Richmond, VA (US); Rakesh KOUL, Glen Allen, VA (US); Nicholas MAGUIRE, Crozier, VA (US); Krystle C. VOSS, Richmond, VA (US); Taimore KHAN, Richmond, TX (US); Jason BAUMGARTNER, Richmond, VA (US); Senthil K. SURIYANARAYANAN, Glen Allen, VA (US); Robert C. STETTLER, Powhatan, VA (US); Harold A. SELL, Glen Allen, VA (US); Anna ROSS, Chicago, IL (US); Erin KIRBY, Glen Allen, VA (US); Benjamin CHRISTENSON, Minneapolis, MN (US)

(21) Appl. No.: 19/061,611

(22) Filed: Feb. 24, 2025

(51) Int. Cl. G06F 21/31; G06F 21/62

(52) U.S. Cl. CPC G06F 21/31; G06F 21/6245

(57) ABSTRACT

In some implementations, a device may obtain a request including a secondary credential. The device may identify a primary credential associated with the secondary credential, the secondary credential being one of a set of secondary credentials associated with the primary credential. The device may retrieve health information associated with a plurality of cells indicated in a cell registry. The device may select a target cell for processing the request, the target cell being one of the plurality of cells and being selected based on the primary credential, the cell registry, and the health information. The device may provide the request to the target cell.

### BACKGROUND

A user of a transaction medium may attempt to perform a transaction using the transaction medium. Such a transaction needs to be authorized by an entity that manages an account associated with the transaction medium. In general, authorization of a transaction may include verifying validity of the transaction, ensuring that the transaction medium is active, ensuring that the account and/or transaction medium is within an applicable limit, ensuring that the transaction is not fraudulent, or the like.

### SUMMARY

Some implementations described herein relate to a device for authorization request routing in a cell-based authorization request processing system. The device may include one or more memories and one or more processors communicatively coupled to the one or more memories. The one or more processors may be configured to obtain an authorization request including a medium credential. The one or more processors may be configured to identify an account credential associated with the medium credential, the medium credential being one of a set of medium credentials associated with the account credential. The one or more processors may be configured to retrieve health information associated with a plurality of cells indicated in a cell registry. The one or more processors may be configured to select a target cell for processing the authorization request, the target cell being one of the plurality of cells and being selected based on the account credential, the cell registry, and the health information. The one or more processors may be configured to route the authorization request to the target cell.

Some implementations described herein relate to a method for request routing in a cell-based authorization request processing system. The method may include obtaining, by a device, a request including a secondary credential. The method may include identifying, by the device, a primary credential associated with the secondary credential, the secondary credential being one of a set of secondary credentials associated with the primary credential. The method may include retrieving, by the device, health information associated with a plurality of cells indicated in a cell registry. The method may include selecting, by the device, a target cell for processing the request, the target cell being one of the plurality of cells and being selected based on the primary credential, the cell registry, and the health information. The method may include providing, by the device, the request to the target cell.

Some implementations described herein relate to a non-transitory computer-readable medium that stores a set of instructions. The set of instructions, when executed by one or more processors of a device, may cause the device to obtain an authorization request including a medium credential. The set of instructions, when executed by one or more processors of the device, may cause the device to identify an account credential associated with the medium credential, the medium credential being one of a set of medium credentials associated with the account credential. The set of instructions, when executed by one or more processors of the device, may cause the device to obtain health information associated with a plurality of cells indicated in a cell registry. The set of instructions, when executed by one or more processors of the device, may cause the device to identify a target cell for processing the authorization request, the target cell being one of the plurality of cells and being identified based on the account credential, the cell registry, and the health information. The set of instructions, when executed by one or more processors of the device, may cause the device to route the authorization request to the target cell.

### BRIEF DESCRIPTION OF THE DRAWINGS

FIGS. 1A-1D are diagrams of an example associated with authorization request routing in a cell-based authorization request processing system, in accordance with some embodiments of the present disclosure.

FIG. 2 is a diagram of an example environment in which devices, systems, and/or methods described herein may be implemented, in accordance with some embodiments of the present disclosure.

FIG. 3 is a diagram of example components of a device associated with authorization request routing in a cell-based authorization request processing system, in accordance with some embodiments of the present disclosure.

FIG. 4 is a flowchart of an example process associated with authorization request routing in a cell-based authorization request processing system, in accordance with some embodiments of the present disclosure.

### DETAILED DESCRIPTION

The following detailed description of example implementations refers to the accompanying drawings. The same references in different drawings may identify the same or similar elements.

A user of a transaction medium (e.g., a transaction card) may attempt to perform a transaction using the transaction medium. Such a transaction needs to be authorized by an entity (e.g., a financial institution) that manages an account associated with the transaction medium. In general, authorization of a transaction may include verifying validity of the transaction, ensuring that the transaction medium is active, ensuring (e.g., using open-to-buy (OTB) calculation) that the account and/or transaction medium is within an applicable limit, ensuring that the transaction is free from fraud, or the like.

Conventionally, an entity relies on an external (e.g., third-party) system for batch processing of requests for authorizations associated with transactions. However, reliance on an external system is disadvantageous for a number of reasons. For example, innovation and adaptation with respect to evolving needs associated with authorization request processing is difficult or impossible because the entity does not have control of the processing system. Further, such systems conventionally use a batch-processing technique and are not scalable, meaning that low latency (e.g., during peak transaction periods) cannot be guaranteed. Additionally, such external systems are not capable of providing direct connections and deep data integration that could otherwise be used to strengthen fraud prevention capabilities. Further, the use of such an external system may have an undesirable monetary cost.

Some implementations described herein provide techniques and apparatuses for authorization request routing in a cell-based authorization request processing system. In some implementations, a cell-based authorization request processing system is used for processing of authorization requests. In one example, the cell-based authorization request processing system comprises a plurality of cells (e.g., separate authorization request processing devices) and one or more routing devices. In operation, a routing device obtains an authorization request including a medium credential, and identifies an account credential associated with the medium credential, with the medium credential being one of a set of medium credentials associated with the account credential. The routing device then retrieves health information associated with the plurality of cells of the cell-based processing system (e.g., as indicated in a cell registry), and selects a target cell for processing the authorization request. The target cell may be selected based on the account credential, the cell registry, and the health information. The routing device then routes the authorization request to the target cell (e.g., such that the authorization request can be processed at the target cell).

In some implementations, a cell-based authorization request processing system including a routing device described herein achieves increased resiliency and reliability (e.g., as compared to a conventional external system) by supporting dynamic redirection of authorization requests among cells in a cell-based system so as to maintain availability, even if one or more cells experience issues and are no longer capable of processing authorization requests. Further, the techniques and apparatuses described herein enhance performance by optimizing resource utilization and managing data affinity, which leads to faster processing of authorization requests. Additionally, the techniques and apparatuses described herein provide scalability that enables seamless handling of increased transaction volumes. Furthermore, the techniques and apparatuses described herein improve fault tolerance by taking into account (e.g., in real-time or near real-time) cell health and redistributing authorization requests based on a configuration. This configuration-driven approach simplifies maintenance and adaptation of routing of authorization requests in the cell-based system. Additionally, the techniques and apparatuses described herein facilitates proactive authorization request management and ensures service continuity by supporting automatic redirection of authorization requests when one or more cells are overburdened or become degraded. Further, the cell-based authorization request processing system can achieve high operational efficiency by enabling support for intervention on an as-needed basis to reconfigure cell partitioning, without significant technical intervention or disruption in service to users. Indeed, the automatic redirection described herein may be transparent to users in order to avoid pauses or downtime from the user's perspective. Additional details are provided below.

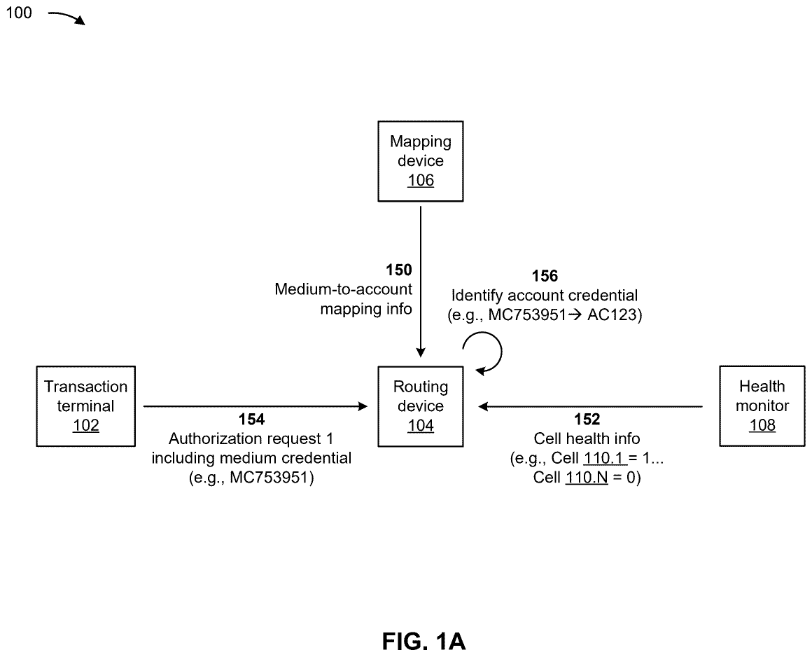

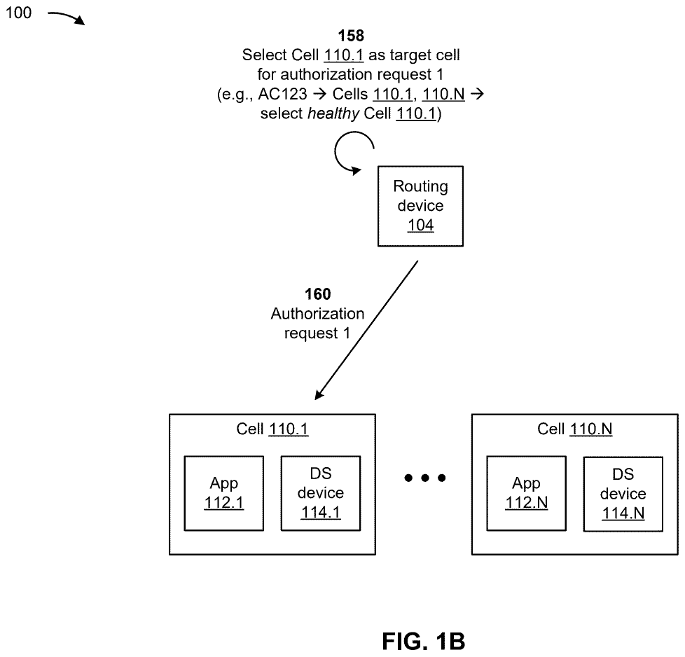

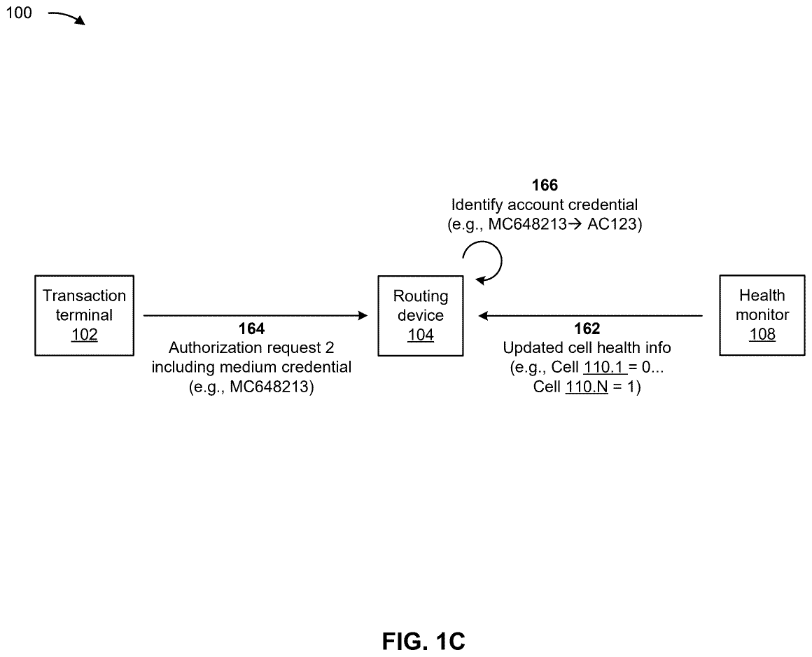

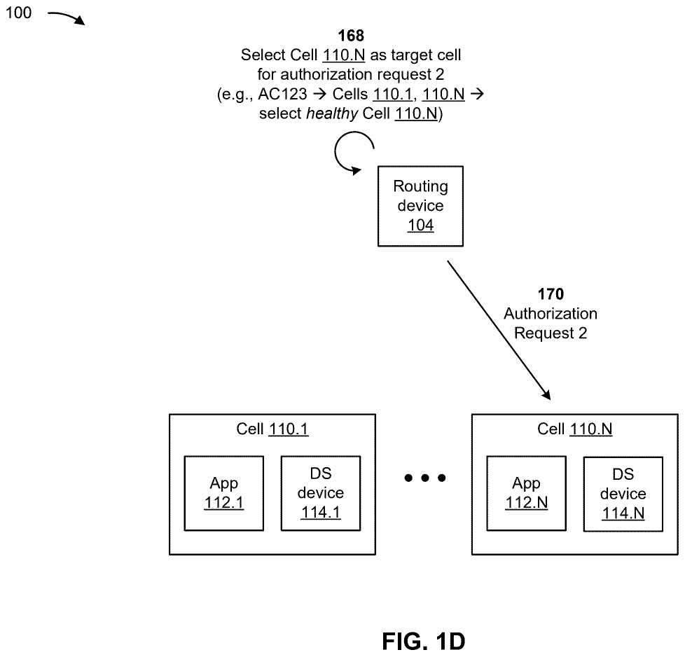

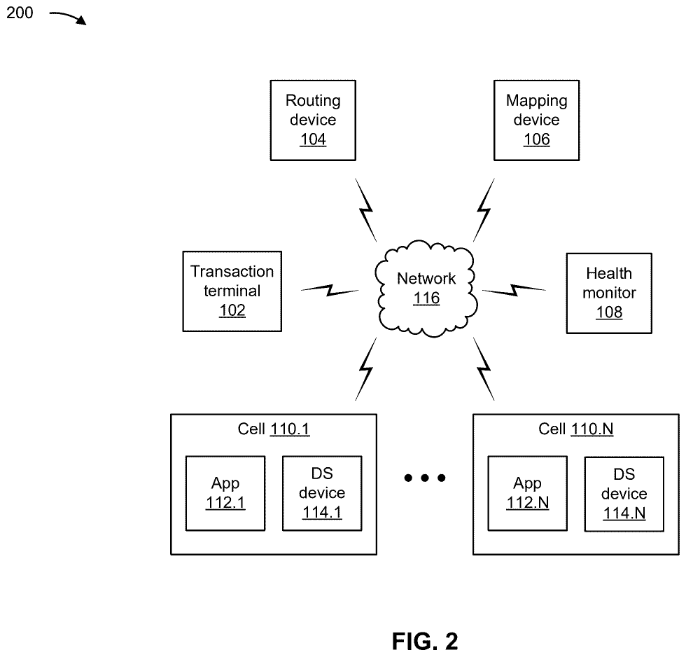

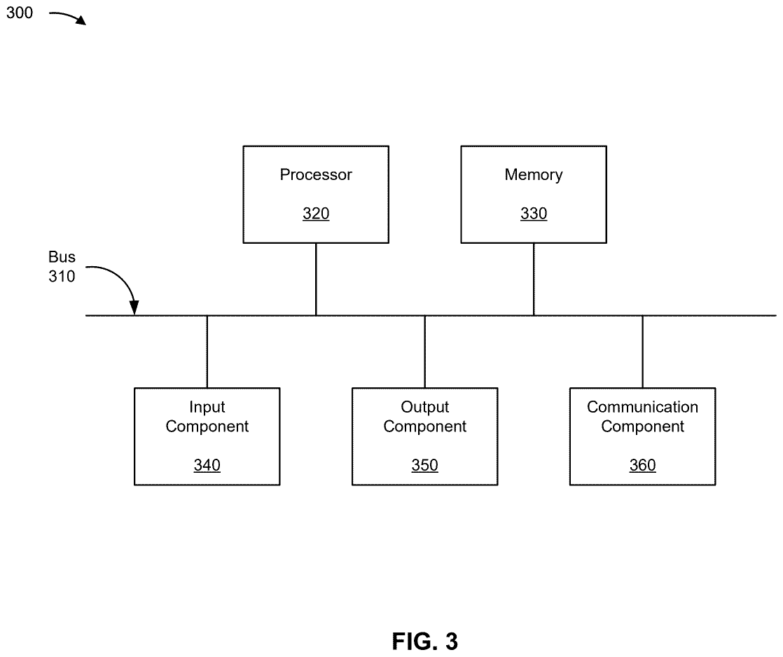

FIGS. 1A-1D are diagrams of an example 100 associated with authorization request routing in a cell-based authorization request processing system. As shown in FIGS. 1A-1D, example 100 includes a transaction terminal 102, a routing device 104, a mapping device 106, a health monitor 108, a plurality of cells 110 (e.g., cell 110.1 through cell 110.N (N>1)) each comprising an associated application component 112 (e.g., app 112.1 through app 112.N) and an associated data structure device 114 (e.g., DS device 114.1 through DS device 114.N). These devices are described in more detail in connection with FIGS. 2 and 3.

As shown at reference 150 in FIG. 1A, the routing device 104 may obtain, from the mapping device 106, medium-to-account mapping information. In some implementations, the medium-to-account mapping information includes information that maps medium credentials (e.g., transaction card numbers) to account credentials (e.g., account identifiers). Thus, in some implementations, the medium-to-account mapping information can be used to identify an account credential (also referred to as a primary credential) with which a medium credential (also referred to as a secondary credential) is associated. In some implementations, multiple medium credentials may be associated with a given account credential (e.g., multiple transaction card numbers may be associated with the same account identifier).

In some implementations, the medium-to-account mapping information comprises a memory mapped array that maps medium credentials to account credentials. In some implementations, the mapping device 106 may generate the medium-to-account mapping information. For example, the mapping device 106 may obtain (e.g., from a data repository) data that indicates associations of medium credentials to account credentials. In some implementations, the mapping device 106 may perform a transformation of the data such that a resulting size of the medium-to-account mapping information is reduced (e.g., as compared to a size of the original data). For example, the mapping device 106 may transform the data such that the medium-to-account mapping information comprises two columns of data. The mapping device 106 may then store the medium-to-account mapping information in a memory location that is accessible by the routing device 104. In some implementations, the mapping device may store a file comprising the medium-to-account mapping information (e.g., after the transformation by the mapping device 106). The routing device 104 may then load the file comprising the medium-to-account mapping information into memory using a memory mapping technique. The data transformation and memory mapping technique allows the routing device 104 to perform a lookup efficiently even when a size of the file size exceeds available memory on the routing device 104 by accessing memory on disk directly without loading contents into the memory of the routing device 104. Rather, the routing device 104 may perform a binary search within the medium-to-account mapping information to identify an account credential associated with a medium credential, as described below. In some implementations, the use of memory mapping reduces latency with respect to identification of an account credential associated with a given authorization request. For example, a load time associated with a binary search of a memory mapped byte array of a few hundred million records may be under approximately two seconds, while a load time associated with a hash map of the same few hundred million records may be several minutes. In some implementations, the mapping device 106 (and its file loading and searching) may be disabled (or omitted altogether) when request routing is based on other information or is not performed.

As shown at reference 152, the routing device 104 may retrieve, from the health monitor 108, health information associated with a plurality of cells 110. In some implementations, the health information indicates whether a given cell 110 is capable of performing authorization request processing. For example, as shown in FIG. 1A, the health information may indicate (e.g., using a bit set to a value of 1) that a cell 110.1 is capable of performing authorization request processing, and may indicate (e.g., using a bit set to a value of 0) that a cell 110.N is not capable of performing authorization request processing. In some implementations, the indication associated with a given cell 110 may be a binary indication (e.g., a single bit set to a value of 1 or a value of 0). In some implementations, the health monitor 108 may obtain health information associated with a given cell 110 (automatically) on a periodic basis (e.g., cells 110 may be configured to periodically provide health information to the health monitor 108). Additionally, or alternatively, the health monitor 108 may (automatically) obtain the health information on an event-driven basis (e.g., a given cell 110 may be configured to provide updated health information when health of the cell 110 changes). Additionally, or alternatively, the health monitor 108 may obtain the health information upon requesting the health information from a given cell 110.

In some implementations, the routing device 104 may retrieve the health information from the health monitor 108. For example, the health monitor 108 may be configured to collect, from each of the plurality of cells 110, health information associated with the plurality of cells 110, and to provide the health information to the routing device 104. In some implementations, the health monitor 108 may provide the health information (automatically) on a periodic basis. Additionally, or alternatively, the health monitor 108 may (automatically) provide the health information on an event-driven basis (e.g., the health monitor 108 may provide updated health information when health of a cell 110 changes). Additionally, or alternatively, the health monitor 108 may provide the health information upon request from the routing device 104.

In some implementations, the health information may indicate a health of each cell 110 in a plurality of cells 110 indicated in a cell registry that is accessible by the routing device 104. The cell registry may in some implementations include a configuration that lists cells 110 associated with processing authorization requests. In some implementations, the list of cells 110 may include sets of cells 110 each of which are associated with a different account credential. In some implementations, the cell registry may include information that identifies a given cell 110 (e.g., a cell identifier), as well as information that associates the given cell 110 with one or more account credentials. Thus, the cell registry may identify one or more cells 110 that are to process authorization requests associated with a given account credential. In some implementations, the cell registry may be published to a storage object, and the routing device 104 may be subscribed to the storage object (e.g., such that the routing device 104 loads the cell registry to memory upon initialization and/or upon periodically checking for cell registry updates).

As shown at reference 154, the routing device 104 may obtain an authorization request including a medium credential. For example, in the example 100, the transaction terminal 102 may transmit, and the routing device 104 may receive, a first authorization request (e.g., authorization request 1) including a first medium credential (e.g., MC753951).

As shown at reference 156, the routing device 104 may identify an account credential associated with the medium credential. In some implementations, as noted above, the medium credential may be one of a set of medium credentials associated with the account credential. In some implementations, the routing device 104 identifies the account credential based on the medium-to-account mapping information obtained as described above with respect to reference 150. For example, the routing device 104 may perform a binary search within the medium-to-account mapping information based on the medium credential, a result of which provides the account credential associated with the medium credential. In the example 100, the routing device 104 identifies a particular account credential (e.g., AC123) as being associated with the first medium credential (e.g., MC753951).

As shown at reference 158 in FIG. 1B, the routing device 104 may select a target cell 110 for processing the authorization request. In some implementations, the target cell 110 is one of the plurality of cells 110 indicated in the cell registry, and is selected based on the account credential, the cell registry, and the health information. For example, the cell registry may identify a pool of cells 110, of the plurality of cells 110, that are associated with the account credential (e.g., a pool of cells 110 to which authorization requests associated with the account credential are to be routed). The health information may indicate whether each cell 110 in the pool of cells 110 is healthy (e.g., whether each cell 110 in the pool of cells 110 is capable of processing authorization requests). Thus, the routing device 104 may identify a pool of cells 110 based on the account credential, and may identify one or more healthy cells 110 from the pool of cells 110 based on the health information. The routing device 104 may then select one of the identified healthy cells 110 from the pool of cells 110 as the target cell 110 for processing the authorization request.

In some implementations, the pool of cells 110 (i.e., the pool of cells 110 that are to process authorization requests associated with the account credential) may include multiple cells 110. In one example, the pool of cells 110 may include a first cell 110 (e.g., the cell 110.1) and a second cell 110 (e.g., the cell 110.N), and the health information may indicate that the first cell 110 is healthy (e.g., that the first cell 110 is capable of processing authorization requests) and that the second cell 110 is not healthy (e.g., that the second cell 110 is not capable of processing authorization requests). In this example, the routing device 104 may select the first cell 110 as the target cell because the second cell 110 is not a healthy cell 110. As a particular example, as shown with respect to example 100, the pool of cells 110 associated with the account credential (e.g., AC123) includes the cell 110.1 and the cell 110.N, and the health information indicates that the cell 110.1 is healthy and that the cell 110.N is not healthy. Therefore, the routing device 104 may select the cell 110.1 as the target cell 110 for the first authorization request.

When mapping data is unavailable (e.g., the routing device 104 may fail to identify a pool of cells 110 to which authorization requests associated with the account credential are to be routed), the routing device 104 may select the target cell based on content of the authorization request (along with the health information, as described above). For example, authentication requests that are similar (e.g., associated with a same account credential) may be routed to a same target cell (provided, for example, that the target cell is healthy).

In another example, the pool of cells 110 may include a first cell 110 and a second cell 110, and the health information may indicate that both the first cell 110 and the second cell 110 are healthy. In some such implementations, the routing device 104 may select the target cell 110 based on a load balancing associated with the pool of cells 110. That is, the routing device 104 may select the target cell 110 from the pool of cells 110 so as to provide load balancing among the pool of cells 110. Alternatively, the routing device 104 may select the target cell 110 in another manner, such as based on a random selection from healthy cells 110 in the pool of cells 110, based on a predefined selection order associated with the pool of cells 110, or the like.

As shown at reference 160, the routing device 104 may route the authorization request to the target cell 110. For example, with respect to example 100, the routing device 104 may route the first authorization request to the target cell 110, which in this example is cell 110.1.

In some implementations, the routing device 104 may receive updated health information associated with the plurality of cells 110. For example, a status of a given cell 110 may change (e.g., such that a previously healthy cell is no longer healthy, or such that a previously not healthy cell has become healthy). Here, the health monitor 108 may obtain updated health information associated with the cell 110, and the routing device 104 may retrieve the updated health information from the health monitor 108. In some implementations, the updated health information may enable dynamic routing of authorization requests by the routing device 104 (e.g., such that health of the cells 110 is accounted for in real-time or near real-time with respect to routing of authorization requests).

For example, as shown at reference 162 in FIG. 1C, the routing device 104 may retrieve updated health information. Here, the updated health information includes an indication that the cell 110.1 (e.g., the target cell selected by the routing device 104 for routing of the first authorization request as described with respect to reference 158 of FIG. 1B) is no longer capable of processing authorization requests (e.g., that the cell 110.1 is no longer healthy). In this example, the updated health information further indicates that the cell 110.N (e.g., a cell 110 that was previously not healthy) is now capable of performing authorization request processing.

In this example, as shown at reference 164, the routing device 104 may receive a second authorization request (e.g., authorization request 2) including a second medium credential (e.g., MC648213). As shown at reference 166, the routing device 104 may identify an account credential, associated with the second medium credential, based on the medium-to-account mapping information. For example, the routing device 104 may perform a binary search within the medium-to-account mapping information based on the second medium credential, a result of which provides the account credential associated with the second medium credential. In the example 100, the routing device 104 identifies the particular account credential (e.g., AC123) as being associated with the second medium credential (e.g., MC648213). That is, in this example, the second medium credential and the first medium credential are associated with the same account credential.

As shown at reference 168 in FIG. 1D, the routing device 104 may select a target cell 110 for processing the second authorization request. As described above, the target cell 110 may be one of the plurality of cells 110 indicated in the cell registry, and may be selected based on the account credential, the cell registry, and the health information. With respect to example 100, the pool of cells 110 associated with the account credential (e.g., AC123) includes the cell 110.1 and the cell 110.N as described above. Further, the updated health information indicates that the cell 110.1 is not healthy and that the cell 110.N is healthy. Therefore, the routing device 104 may select the cell 110.N as the target cell 110 for the second authorization request.

As shown at reference 170, the routing device 104 may route the authorization request to the target cell 110. For example, with respect to example 100, the routing device 104 may route the second authorization request to the target cell 110, which in this example is cell 110.N.

In this way, a cell-based authorization request processing system may use one or more routing devices 104 to support distribution of (high volume) authorization requests (e.g., millions per day) such that authorization requests associated with particular account credentials are routed to designated cells 110. In some implementations, the routing device 104 ensures consistent routing to the same cell 110 for all associated transaction mediums associated with a given account credential. Further, the routing device 104 described herein achieves intelligent routing of authorization requests based on cell health, manual intervention (e.g., configuration), and deployment strategies of cells 110. Notably, the routing device 104 achieves these objectives in a manner that does not result in collapse of routing, even in the event of disaster that affects multiple cells 110. Rather, one or more routing devices 104 can serve to ensure that authorization requests are dynamically routed to healthy cells 110.

Additionally, the routing device 104 described herein is capable of handling a scenario in which a first (e.g., primary) target cell 110 is reported as unhealthy or when the routing device 104 itself has detected connectivity issues with the first target cell 110. In such a scenario, the routing device 104 can facilitate routing of authorization requests to another (healthy) cell 110.

In some implementations, the routing device 104 may perform one or more other operations associated with authorization request processing. For example, after processing of the authorization request by the target cell 110, the routing device 104 may in some implementations obtain, from the target cell 110, an output including a response to the authorization request (e.g., a response indicating whether a transaction associated with the authorization request has been approved). In some such implementations, the routing device 104 may provide the output to the transaction terminal 102.

As another example, the routing device 104 may provide information related to operation of the routing device 104 or one or more cells 110 with respect to authorization request processing. For example, the routing device 104 may publish audit-related information (e.g., to enable analysis of system performance or behavior). As another example, the routing device 104 may publish event-related information (e.g., to comply with a security requirement)

As indicated above, FIGS. 1A-1D are provided as an example. Other examples may differ from what is described with regard to FIGS. 1A-1D.

FIG. 2 is a diagram of an example environment 200 in which devices, systems, and/or methods described herein may be implemented. As shown in FIG. 2, environment 200 may include a transaction terminal 102, a routing device 104, a mapping device 106, a health monitor 108, a plurality of cells 110 (e.g., cell 110.1 through cell 110.N (N>1)) each comprising an associated application component 112 and a data structure device 114, and a network 116. Devices of environment 200 may interconnect via wired connections, wireless connections, or a combination of wired and wireless connections.

The transaction terminal 102 may include one or more devices capable of facilitating an electronic transaction. For example, the transaction terminal 102 may include a point-of-sale (PoS) terminal, a payment terminal (e.g., a credit card terminal, a contactless payment terminal, a mobile credit card reader, or a chip reader), and/or an automated teller machine (ATM). The transaction terminal 102 may include one or more input components and/or one or more output components to facilitate obtaining data (e.g., an authorization request, transaction information, or the like) from a transaction device (e.g., a transaction card, a mobile device executing a payment application, or the like) and/or to facilitate interaction with and/or authorization from an owner or accountholder of the transaction device. Example input components of the transaction terminal 102 include a number keypad, a touchscreen, a magnetic stripe reader, a chip reader, and/or a radio frequency (RF) signal reader (e.g., a near-field communication (NFC) reader). Example output devices of transaction terminal 102 include a display and/or a speaker.

The routing device 104 may include one or more devices capable of receiving, processing, storing, routing, and/or providing traffic (e.g., an authorization request) in a manner described herein. For example, the routing device 104 may include a router, such as a label switching router (LSR), a label edge router (LER), an ingress router, an egress router, a provider router (e.g., a provider edge router or a provider core router), a virtual router, or another type of router. Additionally, or alternatively, the routing device 104 may include a gateway, a switch, a firewall, a hub, a bridge, a reverse proxy, a server (e.g., a proxy server, a cloud server, or a data center server), a load balancer, and/or a similar device. In some implementations, the routing device 104 may be a physical device implemented within a housing, such as a chassis. In some implementations, the routing device 104 may be a virtual device implemented by one or more computing devices of a cloud computing environment or a data center. In some implementations, a group of routing devices 104 may be a group of data center nodes that are used to route traffic flow through a network.

The mapping device 106 may include one or more devices capable of receiving, generating, storing, processing, and/or providing information related to authorization request routing in a cell-based authorization request processing system, as described elsewhere herein. The mapping device 106 may include a communication device and/or a computing device. For example, the mapping device 106 may include a server, such as an application server, a client server, a web server, a database server, a host server, a proxy server, a virtual server (e.g., executing on computing hardware), or a server in a cloud computing system. In some implementations, the mapping device 106 may include computing hardware used in a cloud computing environment.

The health monitor 108 may include one or more devices capable of receiving, generating, storing, processing, and/or providing information related to authorization request routing in a cell-based authorization request processing system, as described elsewhere herein. The health monitor 108 may include a communication device and/or a computing device. For example, the health monitor 108 may include a server, such as an application server, a client server, a web server, a database server, a host server, a proxy server, a virtual server (e.g., executing on computing hardware), or a server in a cloud computing system. In some implementations, the health monitor 108 may include computing hardware used in a cloud computing environment.

A cell 110 may include one or more devices capable of receiving, generating, storing, processing, and/or providing information associated with an authorization request and/or performing processing of the authorization request, as described herein. In some implementations, a given cell 110 includes an application component (app) 112 and a data structure (DS) device 114. The application component 112 may include one or more one or more devices capable of receiving, generating, storing, processing, and/or providing information (e.g., data) associated with processing an authorization request in a cell-based authorization request processing system. The application component 112 may include a communication device and/or a computing device. For example, the application component 112 may include a server, such as an application server, a client server, a web server, a database server, a host server, a proxy server, a virtual server (e.g., executing on computing hardware), or a server in a cloud computing system. In some implementations, the application component 112 may include computing hardware used in a cloud computing environment. The data structure device 114 may include one or more devices capable of receiving, generating, storing, processing, and/or providing information (e.g., data) associated with authorization request routing in a cell-based authorization request processing system, as described elsewhere herein. The data structure device 114 may include a communication device and/or a computing device. For example, the data structure device 114 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. In some implementations, the data structure device 114 may include one or more databases.

The network 116 may include one or more wired and/or wireless networks. For example, the network 116 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 116 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with authorization request routing in a cell-based authorization request processing system. The device 300 may correspond to a transaction terminal 102, a routing device 104, a mapping device 106, a health monitor 108, a calibration l10, an application component 112, and/or a data structure device 114. In some implementations, a transaction terminal 102, a routing device 104, a mapping device 106, a health monitor 108, a cell 110, an application component 112, and/or a data structure device 114 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

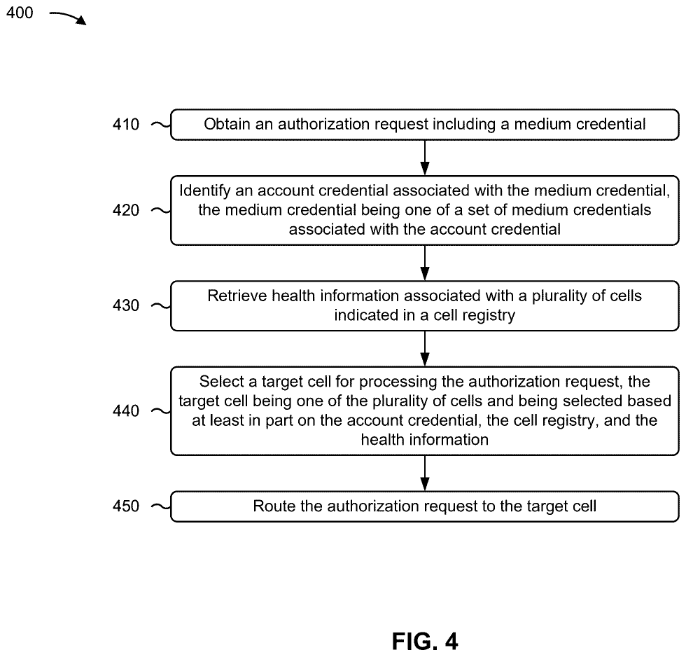

FIG. 4 is a flowchart of an example process 400 associated with authorization request routing in a cell-based authorization request processing system. In some implementations, one or more process blocks of FIG. 4 may be performed by the routing device 104. In some implementations, one or more process blocks of FIG. 4 may be performed by another device or a group of devices separate from or including the routing device 104, such as the transaction terminal 102, the mapping device 106, the health monitor 108, a cell 110, and/or a component of a cell 110 (e.g., an app 112 or a data structure device 114). Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining an authorization request including a medium credential (block 410). For example, the routing device 104 (e.g., using processor 320 and/or memory 330) may obtain an authorization request including a medium credential, as described above in connection with reference 154 of FIG. 1A. As an example, the routing device 104 may receive a first authorization request (e.g., authorization request 1) including a first medium credential (e.g., MC753951).

As further shown in FIG. 4, process 400 may include identifying an account credential associated with the medium credential, the medium credential being one of a set of medium credentials associated with the account credential (block 420). For example, the routing device 104 (e.g., using processor 320 and/or memory 330) may identify an account credential associated with the medium credential, the medium credential being one of a set of medium credentials associated with the account credential, as described above in connection with reference 156 of FIG. 1A. As an example, the routing device 104 may identify a particular account credential (e.g., AC123) as being associated with the first medium credential (e.g., MC753951).

As further shown in FIG. 4, process 400 may include retrieving health information associated with a plurality of cells indicated in a cell registry (block 430). For example, the routing device 104 (e.g., using processor 320 and/or memory 330) may retrieve health information associated with a plurality of cells indicated in a cell registry, as described above in connection with reference 152 of FIG. 1A. As an example, the routing device 104 may retrieve health information indicating that a cell 110.1 is capable of performing authorization request processing, and that a cell 110.N is not capable of performing authorization request processing.

As further shown in FIG. 4, process 400 may include selecting a target cell for processing the authorization request, the target cell being one of the plurality of cells and being selected based on the account credential, the cell registry, and the health information (block 440). For example, the routing device 104 (e.g., using processor 320 and/or memory 330) may select a target cell for processing the authorization request, the target cell being one of the plurality of cells and being selected based on the account credential, the cell registry, and the health information, as described above in connection with reference 158 of FIG. 1B. As an example, a pool of cells 110 associated with the account credential (e.g., AC123) may include the cell 110.1 and the cell 110.N, and the routing device 104 may select the cell 110.1 as the target cell 110 for the first authorization request.

As further shown in FIG. 4, process 400 may include routing the authorization request to the target cell (block 450). For example, the routing device 104 (e.g., using processor 320 and/or memory 330) may route the authorization request to the target cell, as described above in connection with reference 160 of FIG. 1B. As an example, the routing device 104 may route the first authorization request to the cell 110.1.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for authorization request routing in a cell-based authorization request processing system, the device comprising:
one or more memories; and
one or more processors, communicatively coupled to the one or more memories, configured to:
obtain an authorization request including a medium credential;
identify an account credential associated with the medium credential, the medium credential being one of a set of medium credentials associated with the account credential;
retrieve health information associated with a plurality of cells indicated in a cell registry;
select a target cell for processing the authorization request, the target cell being one of the plurality of cells and being selected based on the account credential, the cell registry, and the health information; and
route the authorization request to the target cell.

2. The device of claim 1, wherein the health information includes an indication that a particular cell, of the plurality of cells and that is associated with the account credential, is capable of performing authorization request processing, wherein the particular cell is selected as the target cell based on the indication.

3. The device of claim 1, wherein the health information includes a first indication that a first cell, of the plurality of cells and that is associated with the account credential, is not capable of performing authorization request processing, and includes a second indication that a second cell, of the plurality of cells and that is associated with the account credential, is capable of performing authorization request processing, wherein the second cell is selected as the target cell based on the first indication and the second indication.

4. The device of claim 1, wherein the authorization request is a first authorization request, the medium credential is a first medium credential, the target cell is a first target cell, and the one or more processors are further configured to:
obtain a second authorization request including a second medium credential;
identify the account credential as being associated with the second medium credential;
select a second target cell for processing the second authorization request, the second target cell being one of the plurality of cells and being selected based on the account credential, the cell registry, and the health information; and
route the second authorization request to the second target cell.

5. The device of claim 4, wherein the one or more processors are further configured to retrieve updated health information including an indication that the first target cell is no longer capable of performing authorization request processing, wherein the second target cell is selected based on the updated health information.

6. The device of claim 4, wherein the first target cell and the second target cell are included in a pool of cells, of the plurality of cells, that are associated with the account credential, and the second target cell is selected based on a load balancing associated with the pool of cells.

7. The device of claim 1, wherein the one or more processors, to identify the account credential, are configured to perform a binary search in a memory mapped array that maps medium credentials to account credentials.

8. The device of claim 1, wherein the one or more processors are further configured to:
obtain an output including a response to the authorization request; and
provide the output including the response to the authorization request.

9. A method for request routing in a cell-based authorization request processing system, comprising:
obtaining, by a device, a request including a secondary credential;
identifying, by the device, a primary credential associated with the secondary credential, the secondary credential being one of a set of secondary credentials associated with the primary credential;
retrieving, by the device, health information associated with a plurality of cells indicated in a cell registry;
selecting, by the device, a target cell for processing the request, the target cell being one of the plurality of cells and being selected based on the primary credential, the cell registry, and the health information; and
providing, by the device, the request to the target cell.

10. The method of claim 9, wherein the health information includes an indication that a particular cell, of the plurality of cells and that is associated with the primary credential, is capable of performing request processing, wherein the particular cell is selected as the target cell based on the indication.

11. The method of claim 9, wherein the health information includes a first indication that a first cell, of the plurality of cells and that is associated with the primary credential, is not capable of performing request processing, and includes a second indication that a second cell, of the plurality of cells and that is associated with the primary credential, is capable of performing request processing, wherein the second cell is selected as the target cell based on the first indication and the second indication.

12. The method of claim 9, wherein the authorization request is a first authorization request, the medium credential is a first medium credential, the target cell is a first target cell, and the method further comprises:
obtaining a second request including a second secondary credential;
identifying the primary credential as being associated with the second secondary credential;
selecting a second target cell for processing the second request, the second target cell being one of the plurality of cells and being selected based on the primary credential, the cell registry, and the health information; and
routing the second request to the second target cell.

13. The method of claim 12, further comprising retrieving updated health information including an indication that the first target cell is no longer capable of performing request processing, wherein the second target cell is selected based on the updated health information.

14. The method of claim 12, wherein the first target cell and the second target cell are included in a pool of cells, of the plurality of cells, that are associated with the primary credential, and the second target cell is selected based on a load balancing associated with the pool of cells.

15. The method of claim 9, wherein identifying the primary credential comprises performing a binary search in a memory mapped array that maps secondary credentials to primary credentials.

16. The method of claim 9, further comprising:
obtaining an output including a response to the request; and
providing the output including the response to the request.

17. A non-transitory computer-readable medium storing a set of instructions, the set of instructions comprising:
one or more instructions that, when executed by one or more processors of a device, cause the device to:
obtain an authorization request including a medium credential;
identify an account credential associated with the medium credential, the medium credential being one of a set of medium credentials associated with the account credential;
obtain health information associated with a plurality of cells indicated in a cell registry;
identify a target cell for processing the authorization request, the target cell being one of the plurality of cells and being identified based on the account credential, the cell registry, and the health information; and
route the authorization request to the target cell.

18. The non-transitory computer-readable medium of claim 17, wherein the health information includes an indication that a particular cell, of the plurality of cells and that is associated with the account credential, is capable of performing authorization request processing, wherein the particular cell is identified as the target cell based on the indication.

19. The non-transitory computer-readable medium of claim 17, wherein the health information includes a first indication that a first cell, of the plurality of cells and that is associated with the account credential, is not capable of performing authorization request processing, and includes a second indication that a second cell, of the plurality of cells and that is associated with the account credential, is capable of performing authorization request processing, wherein the second cell is identified as the target cell based on the first indication and the second indication.

20. The non-transitory computer-readable medium of claim 17, wherein the one or more instructions further cause the device to:
obtain a second authorization request including a second medium credential;
identify the account credential as being associated with the second medium credential;
identify a second target cell for processing the second authorization request, the second target cell being one of the plurality of cells and being identified based on the account credential, the cell registry, and the health information; and
route the second authorization request to the second target cell.
